(19) United States
(12) Patent Application Publication
(10) Pub. No.: US 2012/0062742 A1
(43) Pub. Date: Mar. 15, 2012

(54) Black box having function of lane recognition and method of processing image using the same

(75) Inventor: In Taek Song, Seongnam (KR)

(73) Assignee: SAMSUNG ELECTRO-MECHANICS CO., LTD., Suwon (KR)

(21) Appl. No.: 13/137,776

(22) Filed: Sep. 12, 2011

(30) Foreign Application Priority Data
Sep. 15, 2010 (KR) 10-2010-0090622

(51) Int. Cl. H04N 7/18

(52) U.S. Cl. 348/148; 348/E07.085

(57) ABSTRACT

There are provided a black box having a function of lane recognition and a method of processing an image using the same. The black box having a function of lane recognition includes: an image photographing module having a first angle of view and photographing a first image taken towards the front of a vehicle; an image storing module compressing and storing the photographed first image; an image cropping module cropping a second image within a second angle of view smaller than the first angle of view of the photographed first image; and a lane departure sensing module extracting a lane from the cropped second image and sensing the lane departure of the vehicle based on the extracted lane, thereby making it possible to reduce cost and efficiently utilize the internal space of a vehicle.

### CROSS-REFERENCE TO RELATED APPLICATIONS

This application claims the priority of Korean Patent

Application No. 10-2010-0090622 filed on Sep. 15, 2010, in the Korean Intellectual Property Office, the disclosure of which is incorporated herein by reference.

### BACKGROUND OF THE INVENTION

1. Field of the Invention

The present invention relates to a black box, and more particularly, to a black box capable of reducing cost and efficiently utilizing an internal space of a vehicle by storing an image taken towards the front of the vehicle, photographed through an image photographing module having a wide angle of view, and cropping an image within a predetermined angle of view from the photographed image to use the cropped image for lane recognition, and a method of processing an image using the same.

2. Description of the Related Art

Generally, a black box is a device mounted in an airplane to discover the cause of an accident. However, in accordance with the recent trend of mounting the black box in a general vehicle, the black box is used to photograph and store an image taken towards the front of the vehicle to be adopted as an important source of evidence for various collision accidents, hit-and-run accidents, or the like, thereby assisting in investigating the cause of a traffic accident.

In addition to the black box, a large number of electronic systems have been mounted in the vehicle. With the aid of these electronic systems, drivers may drive the vehicle more safely. One of these electronic systems is a lane departure warning system. The lane departure warning system is a system for sensing a situation in which the vehicle departs from the corresponding driving lane due to continuous driving for a long time or driving while fatigued, and warning the driver of the situation, thereby attracting driver's attention.

Meanwhile, in terms of characteristics, a camera for the black box should have a wide angle of view, and a camera for sensing the lane departure has a narrow angle of view as compared to the camera for the black box. Accordingly, in order to mount both of the black box and the lane departure warning system in the vehicle, two cameras having different angles of view should be separately mounted, such that an internal space of the vehicle becomes messy or insufficient. In addition, two cameras are mounted, thereby causing increase in cost.

### SUMMARY OF THE INVENTION

An aspect of the present invention provides a black box capable of reducing cost and efficiently utilizing an internal space of a vehicle by sensing lane departure using an image photographing module for a black box, and a method of processing image using the same.

According to an aspect of the present invention, there is provided a black box having a function of lane recognition, including: an image photographing module having a first angle of view and photographing a first image taken towards the front of a vehicle; an image storing module compressing and storing the photographed first image; an image cropping module cropping a second image within a second angle of view smaller than the first angle of view, from the photographed first image; and a lane departure sensing module extracting a lane from the cropped second image and sensing lane departure of the vehicle based on the extracted lane.

The first angle of view may have a value of between 110° and 180°, and the second angle of view may have a value between 5° and 100°.

According to an aspect of the present invention, there is provided a method of processing an image, including; (a) photographing a first image taken towards the front of a vehicle through an image photographing module having a first angle of view; (b) compressing and storing the photographed first image; (c) cropping a second image within a second angle of view smaller than the first angle of view, from the photographed first image; and (d) extracting a lane from the cropped second image and sensing lane departure of the vehicle based on the extracted lane.

The first angle of view may have a value between 110° and 180°, and the second angle of view may have a value between 5° and 100°.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing a configuration of a black box including an image photographing module according to an exemplary embodiment of the present invention; and

FIG. 2 is a flowchart describing a method of processing an image input by using a black box according to an exemplary embodiment of the present invention.

### DETAILED DESCRIPTION OF THE PREFERRED EMBODIMENT

Hereinafter, exemplary embodiments of the present invention will be described in detail with reference to the accompanying drawings.

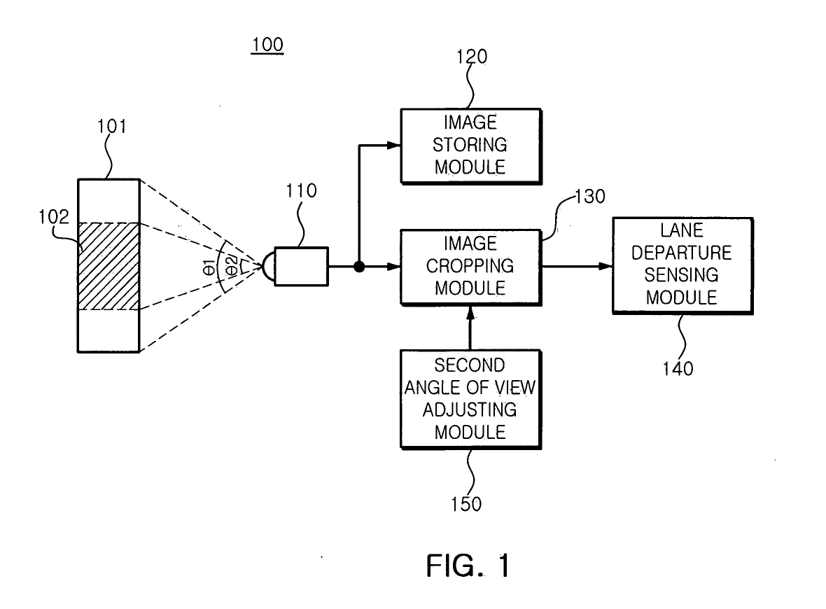

FIG. 1 is a view showing a configuration of a black box including an image photographing module according to an exemplary embodiment of the present invention. The black box may be configured to include an image photographing module 110, an image storing module 120, an image cropping module 130, a lane departure sensing module 140, and a second angle of view adjusting module 150.

Referring to FIG. 1, the image photographing module 110, which is a module for photographing an image, such as a charge coupled device (CCD) camera, is mounted on a rear view mirror, and the like, within a vehicle to photograph an image 101 taken towards the front of the vehicle in real time. The image 101 photographed in real time is transferred to the image storing module 120 and the image cropping module 130. The image photographing module 110 is a camera having a first angle of view (θ1), wherein the first angle of view (θ1) has a value between 110° and 180°, by way of example. The above-mentioned first angle of view (θ1) is only an example, and may be larger or smaller than 110° to 180°.

The image storing module 120 compresses and then stores the image 101 transferred from the image photographing module 110 according to a predetermined compression algorithm. The stored image may be reproduced later.

Meanwhile, the image cropping module 130 crops an image 102 within a second angle of view (θ2) of the image 101 transferred from the image photographing module 110. The cropped image 102 is transferred to the lane departure sensing module 140. Generally, an image photographing module for a black box should have a wide angle of view, and a camera for sensing the lane departure of the vehicle may sufficiently sense the lane departure even with a narrow angle of view as compared to the image photographing module for the black box. Accordingly, according to an exemplary embodiment of the present invention, the image within the angle of view for lane recognition, that is, the second angle of view (θ2) of the image photographed through the image photographing module 110 having the wide angle of view for the black box, that is, the first angle of view (θ1) is cropped to be used as the image for lane recognition. The second angle of view may include a value between 5° and 100°. The existing two cameras may be reduced to one camera through the above-mentioned image cropping module 130, thereby making it possible to reduce cost and efficiently utilize the internal space of a vehicle.

The lane departure sensing module 140 extracts a lane from the cropped image 102 transferred to the image cropping module 130 and senses lane departure based on the extracted lane.

The lane extracting and the lane departure sensing based on the extracted lane may be performed using an existing known algorithm.

Meanwhile, the second angle of view adjusting module 150 transfers an angle of view command for adjusting the magnitude of the second angle of view (θ2) to the image cropping module 130 as needed (for example, user's command). The image cropping module 130 may crop the image according to the second angle of view (θ2) based on the transferred angle of view command.

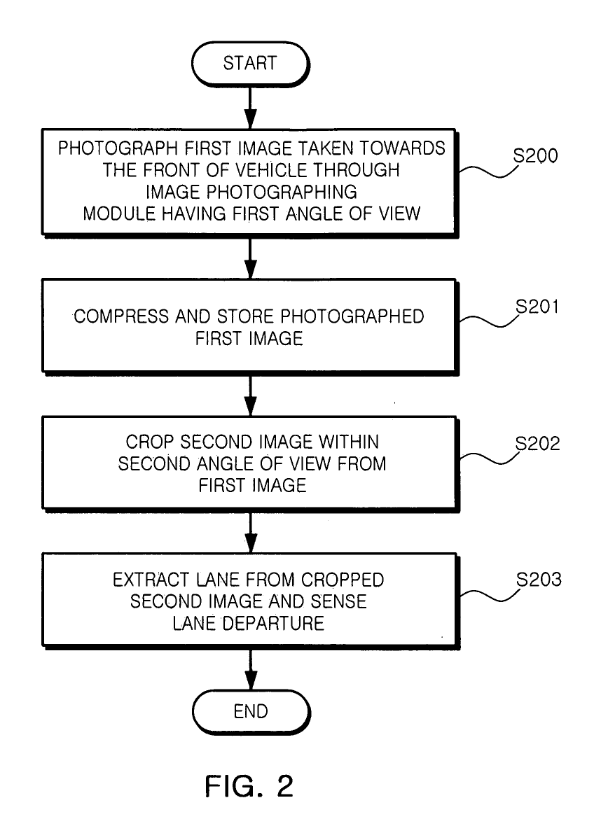

FIG. 2 is a flowchart describing a method of processing an image input using a black box according to an exemplary embodiment of the present invention. A description of aspects of the invention overlapping with the content described above with respect to FIG. 1 will be omitted for the simplification of the description of the present invention.

Referring to FIGS. 1 and 2, in operation S200, the image photographing module 110, which is a module for photographing an image, such as a charge coupled device (CCD) camera, is mounted on a rear view mirror, and the like, within a vehicle to photograph an image 101 taken towards the front of the vehicle in real time. The image 101 photographed in real time is transferred to the image storing module 120 and the image cropping module 130.

In operation S201, the image storing module 120 compresses and then stores the image 101 transferred from the image photographing module 110 according to a predetermined compression algorithm. The stored image may be reproduced later.

Meanwhile, in operation S202, the image cropping module 130 crops an image 102 within a second angle of view (θ2) of the image 101 transferred from the image photographing module 110. The cropped image 102 is transferred to the lane departure sensing module 140.

In step S203, the lane departure sensing module 140 extracts a lane from the cropped image 102 transferred from the image cropping module 130 and senses the lane departure of the vehicle based on the extracted lane. The lane extracting and the lane departure sensing based on the extracted lane may be performed using an existing known algorithm.

As set forth above, according to exemplary embodiments of the present invention, it is possible to reduce cost and efficiently utilize an internal space of a vehicle by storing an image taken towards the front of the vehicle photographed through an image photographing module having a wide angle of view and cropping an image within a predetermined angle of view of the photographed image to use the cropped image for lane recognition.

The present invention is not limited to the above-mentioned exemplary embodiments and the accompanying drawings, but is defined by the appended claims. Accordingly, various substitution, modifications and alteration may be made within the scope of the present invention may be made by those skilled in the art without departing from the spirit of the prevent invention defined by the accompanying claims.

What is claimed is:

1. A black box having a function of lane recognition, comprising:
an image photographing module having a first angle of view and photographing a first image taken towards the front of a vehicle;
an image storing module compressing and storing the photographed first image;
an image cropping module cropping a second image within a second angle of view smaller than the first angle of view, from the photographed first image; and
a lane departure sensing module extracting a lane from the cropped second image and sensing lane departure of the vehicle based on the extracted lane.

2. The black box of claim 1, wherein the first angle of view has a value between 110° and 180°.

3. The black box of claim 1, wherein the second angle of view has a value between 5° and 100°.

4. A method of processing an image, comprising;
(a) photographing a first image taken towards the front of a vehicle through an image photographing module having a first angle of view;
(b) compressing and storing the photographed first image;
(c) cropping a second image within a second angle of view smaller than the first angle of view, from the photographed first image; and
(d) extracting a lane from the cropped second image and sensing lane departure of the vehicle based on the extracted lane.

5. The method of processing an image of claim 4, wherein the first angle of view has a value between 110° and 180°.

6. The method of processing an image of claim 4, wherein the second angle of view has a value between 5° and 100°.
